(19) United States
(12) Patent Application Publication
(10) Pub. No.: US 2014/0266877 A1
(43) Pub. Date: Sep. 18, 2014

(54) PRECISION ACCURACY GLOBAL NAVIGATION SATELLITE SYSTEM (GNSS) WITH SMART DEVICES

(71) Applicant: AgJunction LLC, Hiawatha, KS (US)

(72) Inventors: John A. McClure, Scottsdale, AZ (US); Landon Morris, Hiawatha, KS (US); Greg S. Guyette, Tempe, AZ (US)

(73) Assignee: AgJunction LLC, Hiawatha, KS (US)

(21) Appl. No.: 14/217,063

(22) Filed: Mar. 17, 2014

Related U.S. Application Data
(60) Provisional application No. 61/794,286, filed on Mar. 15, 2013.

(51) Int. Cl. G01S 19/07

(52) U.S. Cl. CPC G01S 19/07
USPC 342/357.44

(57) ABSTRACT

A global navigation satellite system (GNSS) based precision accuracy navigation and location system includes a Smart device with a hardwired Wi-Fi or Bluetooth connection to a GNSS receiver. Differential GNSS corrections are received over the Internet from a base receiver for precision accuracy positioning, GIS, navigation and other applications.

### CROSS-REFERENCE TO RELATED APPLICATION

This application claims priority in U.S. Provisional Patent Application No. 61/794,286, filed Mar. 15, 2013, which is incorporated herein by reference.

### BACKGROUND OF THE INVENTION

1. Field of the Invention

The present invention relates generally to global navigation satellite system (GNSS) devices, and in particular to precision accuracy with smart devices.

2. Description of the Related Art

Smart Devices, wireless hand held devices, using iOS, ANDROID and now Blackberry and Windows operating systems and others, have brought a mass of applications in the mapping field using their internal global positioning system (GPS) receivers, along with their robust field computing capability. This includes underlying maps, routing and real time communication to internet data bases.

These are fine for driving applications where the position can be artificially snapped to the correct, closest road. However, where the user requirement is for a position for a geographic information system (GIS) or for repeatability in positioning a feature or control, such as in agricultural applications for soil sampling, weed recognition, area calculation and control of steering or equipment, these receivers do not have the required accuracy. They have antennae designed to optimize gain in any user held position, all with the goal of generating a position. This design compromises the solution with severe bias and drift in the measured position, even when the units use differential corrections such as from satellite-based augmentation systems (SBAS).

### SUMMARY OF THE INVENTION

A proposal is made for a method to integrate high precision differential GPS systems with Smart Devices to improve the accuracy of their internal GPS receivers and allow their mapping, sampling, tracking, and boundary and control applications to meet the accuracy expectations of their users.

### BRIEF DESCRIPTION OF THE DRAWINGS

The drawings constitute a part of this specification and include exemplary embodiments of the present invention illustrating various objects and features thereof.

FIG. 1 is a precision accuracy global navigation satellite system (GNSS) using differential correction technology with smart devices.

### DETAILED DESCRIPTION OF THE PREFERRED EMBODIMENTS

### I. Introduction and Environment

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Certain terminology will be used in the following description for convenience in reference only and will not be limiting. For example, up, down, front, back, right and left refer to the invention as oriented in the view being referred to. The words “inwardly” and “outwardly” refer to directions toward and away from, respectively, the geometric center of the embodiment being described and designated parts thereof. Said terminology will include the words specifically mentioned, derivatives thereof and words of similar meaning Global navigation satellite systems (GNSS) are broadly defined to include GPS (U.S.), Galileo (proposed), GLONASS (Russia), Beidou (Compass) (China), IRNSS (India, proposed), QZSS (Japan, proposed) and other current and future positioning technology using signals from satellites, with or without augmentation from terrestrial sources. Yaw, pitch and roll refer to moving component rotation about the Z, X and Y axes respectively. Said terminology will include the words specifically mentioned, derivatives thereof and words of similar meaning

### II. Preferred Embodiments

The proposal is to make Smart GNSS devices to communicate with these Smart Devices, replacing their internal receivers with accurate positions to use with their Smart applications, as written by many developers. The Smart GNSS will include positions, attitudes, rates of turn and velocities from single and multiple GNSS antenna systems, allowing for an expansion of applications to include control, additional display and logging.

In addition to support for these proprietary applications the Smart GNSS will have its own internal web server to serve applications and position and attitude data that will be Smart Device Operating System agnostic and use the ubiquitous web browser capability of the Smart Devices, along with its user interface and expandability to other internet sources.

Communication between the Smart GNSS and Smart Device can be over hard wired connection or via other wireless communication methods.

This effectively makes the Smart Device the display head for the Smart GNSS applications, while still maintaining the Smart Device's capability to access other internet sites and data bases for additional data such as maps and file transfers over the cell network. The Smart GNSS applications will setup and control this data transfer using the Smart Device as the display and data entry selection.

FIG. 1 shows a smart device with a hardwired (e.g., Wi-Fi or Bluetooth) connection to a Smart GNSS (GPS) for real-time kinematic (RTK) corrections, Wi-Fi, Bluetooth, Web server and other applications. The Smart device communicates via the cloud and receives differential corrections over the Internet from a base server.

It is to be understood that the invention can be embodied in various forms, and is not to be limited to the examples discussed above. The range of components and configurations which can be utilized in the practice of the present invention is virtually unlimited.

Having thus described the invention, what is claimed as new and desired to be secured by Letters Patent is:

1. A global navigation satellite system (GNSS) based precision accuracy navigation and positioning system, which includes:
a Smart device;
a GNSS receiver connected to the Smart device via a hardwired Wi-Fi or Bluetooth connection;
said Smart device configured for receiving differential GNSS-based positioning corrections via the Internet from a base server.
